(19) United States
(12) Patent Application Publication
(10) Pub. No.: US 2013/0083684 A1
(43) Pub. Date: Apr. 4, 2013

(54) METHODS OF DEVICE TO DEVICE COMMUNICATION

(71) Applicant: Electronics and Telecommunications Research In, Daejeon (KR)

(72) Inventors: Choong Il YEH, Daejeon (KR); Jae Young AHN, Daejeon (KR); Kyoung Seok LEE, Daejeon (KR)

(73) Assignee: Electronics and Telecommunications Research Institute, Daejeon (KR)

(21) Appl. No.: 13/630,160

(22) Filed: Sep. 28, 2012

(30) Foreign Application Priority Data
Sep. 30, 2011 (KR) 10-2011-0100264
Nov. 3, 2011 (KR) 10-2011-0113911
Sep. 25, 2012 (KR) 10-2012-0106320

(51) Int. Cl. H04W 8/26

(52) U.S. Cl. CPC H04W 8/26
USPC 370/252; 370/328

(57) ABSTRACT

Disclosed is a device to device (D2D) communication method. The D2D communication method includes generating a connection identification (CID) for D2D communication using an identification (ID) of a specific terminal, selecting a sequence corresponding to the CID, and transmitting the selected sequence using a paging request resource including a plurality of subcarriers. Accordingly, even in a channel selective wireless environment, a performance of a wireless link may be improved, and usage efficiency of wireless resources may be improved.

### CLAIM FOR PRIORITY

This application claims priority to Korean Patent Application No. 10-2011-0100264 filed on Sep. 30, 2011, Korean Patent Application No. 10-2011-0113911 filed on Nov. 3, 2011, and Korean Patent Application No. 10-2012-0106320 filed on Sep. 25, 2012 in the Korean Intellectual Property Office (KIPO), the entire contents of which are hereby incorporated by reference.

### BACKGROUND

1. Technical Field

Example embodiments of the present invention relate in general to a wireless communication system and more specifically to a device to device (D2D) communication method.

2. Related Art

In a point-to-multipoint wireless communication system, transmission should be performed from a terminal to a base station and from the base station to a counterpart terminal even when data needs to be transmitted and received between adjacent terminals, and therefore a waste and delay of wireless resources may be increased compared to when the terminals directly transmit and receive data to and from each other. To solve the above-described problem, device to device (D2D) communication technology has emerged.

That is, D2D communication may refer to a communication method in which data transmission and reception is directly performed between two adjacent terminals rather than via a base station. That is, in the D2D communication, two terminals respectively become a source of data and a destination of data to thereby perform communication.

FIG. 1 is a conceptual diagram illustrating a concept of D2D communication.

Referring to FIG. 1, a cellular communication network including a first base station 10 and a second base station 20 is shown. In this instance, terminals 11 to 13 included in a cell generated by the first base station 10 perform communication through a typical connection link via the first base station 10, but terminals 14 and 15 included in the first base station 10 may directly perform data transmission and reception between the terminals 14 and 15 rather than via a base station.

There may be a variety of discussions on a user case in which the D2D communication is effectively performed. For example, the D2D communication may be used in a local media server that provides a large amount of materials (for example, a program of a rock concert or information about performers in the rock concert) to visitors attending a rock concert or the like. In this instance, each terminal may be connected with a serving cell to perform phone calls, Internet access, or the like using a conventional cellular link, but the above-described large amount of materials may be transmitted and received, through the D2D communication method, to and from a local media server acting as a counterpart of the D2D communication.

Meanwhile, referring again to FIG. 1, a D2D communication link is not only possible between terminals having the same cell as a serving cell, but may also be possible between terminals having mutually different cells as a serving cell. For example, the terminal 13 included in the first base station 10 may perform D2D communication with a terminal 21 included in the second base station 20.

Due to the above-described characteristics of the D2D communication, the D2D communication technology may be expected to be a basic technology for the Internet of Things (IOT) or a sensor network.

Meanwhile, for the D2D communication, a connection setting process between two terminals is required. Connection setting for D2D communication may include a process in which each terminal acquires synchronism, a discovery process in which each terminal notifies adjacent terminals of its own presence and at the same time recognizes presence of the adjacent terminals, a paging process in which a connection ID (CID) between two adjacent terminals desiring to perform D2D communication is generated, and a traffic transmission/reception process in which two devices perform communication with each other.

In the connection setting process for the D2D communication, a single-tone signaling method has been used in the related art to thereby perform the paging and traffic transmission/reception processes. That is, in the related art, a method in which signals are transmitted using a single subcarrier in a communication environment using orthogonal frequency division multiple access (OFDMA) and signaling is performed using energy level detection of an analog method has been used.

A single-tone signaling technology based on reception power of a specific subcarrier which is measured by a reception terminal performs signaling using only a single specific subcarrier, and therefore a reception performance in a frequency-selective channel environment is reduced.

In addition, an existing connection setting method for D2D communication uses a single subcarrier in a signaling process, and uses all subcarriers in a data transmission process, and therefore arrival distances of signals in the above-described two processes may be different from each other, and efficiency that can be achieved through delicate resource allocation may not be expected.

### SUMMARY

Accordingly, example embodiments of the present invention are provided to substantially obviate one or more problems due to limitations and disadvantages of the related art.

Example embodiments of the present invention provide a device to device (D2D) communication method that may improve a performance of a wireless link and resource usage efficiency.

In some example embodiments, a device to device (D2D) communication method includes: generating a connection identification (CID) for D2D communication using an identification (ID) of a specific terminal; selecting a sequence corresponding to the CID; and transmitting the selected sequence using a paging request resource including a plurality of subcarriers.

Here, the generating may include generating the CID as an output of a hash function using the ID of the specific terminal as an input of the hash function.

Here, the selecting may include selecting the sequence corresponding to the CID from a sequence set including a plurality of pseudo noise (PN) sequences which are set in advance.

Here, after the selecting, the D2D communication method may further include: receiving at least one sequence broadcast from other terminals; and determining whether the generated CID is occupied based on the received at least one sequence.

Here, after the transmitting, the D2D communication method may further include: receiving at least one sequence transmitted from at least one other terminals in a paging response interval; measuring reception power of the sequence corresponding to the generated CID among the received at least one sequence; and determining that a paging response is received when the measured reception power is equal to or larger than a predetermined threshold value.

In other example embodiments, a D2D communication method which is performed in a transmission terminal requesting D2D communication connection includes: transmitting a request to send (RTS) signal by mapping a sequence corresponding to a generated CID in an RTS resource including a plurality of subcarriers; determining whether a transmission abandonment condition is satisfied based on a clear to send (CTS) signal received from a reception terminal; and transmitting a pilot signal when the transmission abandonment condition is satisfied.

Here, the determining may include receiving a sequence mapped in a plurality of subcarriers as the CTS signal, measuring a channel quality based on all of the plurality of subcarriers, and determining that the transmission abandonment condition is satisfied when the measured channel quality is equal to or larger than a predetermined threshold value.

Here, the measuring may include measuring an effective signal to interference ratio (SIR) representing an SIR of each of the plurality of subcarriers.

Here, the transmitting of the pilot signal may include transmitting the sequence corresponding to the CID as the pilot signal.

In still other example embodiments, a D2D communication method which is performed in a reception terminal receiving a request for D2D communication connection includes: receiving an RTS signal; determining whether a reception abandonment condition is satisfied based on the received RTS signal; and transmitting a CTS signal by mapping a sequence corresponding to a generated CID in a plurality of subcarriers when the reception abandonment condition is satisfied.

Here, the determining may include measuring a channel quality based on all of the plurality of subcarriers constituting the received RTS signal, and determining that the reception abandonment condition is satisfied when the measured channel quality is equal to or larger than a predetermined threshold value.

Here, the measuring may include measuring an effective SIR representing an SIR of each of the plurality of subcarriers.

Here, after the transmitting of the CTS signal, the D2D communication method may further include: receiving a pilot signal; and transmitting a channel quality indicator only when reception power of the received pilot signal is equal to or larger than a predetermined threshold value.

According to the above-described D2D communication method, in a paging process of D2D connection setting and a traffic transmission/reception process thereof, signals are transmitted by mapping the PN sequence in the plurality of subcarriers, and therefore a performance of a wireless link may be improved even in a channel selective wireless environment.

In addition, in the traffic transmission/reception process, the transmission terminal and the reception terminal which perform D2D communication connection may test the transmission abandonment condition and the reception abandonment condition using the effective SIR representing the entire channel, and perform distributed scheduling for transmitting a signal only when the transmission abandonment condition and the reception abandonment condition are satisfied, and therefore interference with adjacent terminals may be prevented resulting in an improvement in usage efficiency of wireless resources.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram for illustrating a concept of device to device (D2D) communication;

FIG. 2 is a flowchart illustrating a connection setting process for D2D communication;

FIG. 3 is a drawing illustrating a structure of a frame that is used in a D2D communication process;

FIG. 4 is a flowchart illustrating a paging process of a D2D communication method according to an embodiment of the present invention;

FIG. 5 is a conceptual diagram illustrating the paging process shown in FIG. 4;

FIG. 6 is a conceptual diagram illustrating connection identification (CID) generation and pseudo noise (PN) sequence mapping of a paging process according to an embodiment of the present invention;

FIG. 7 is a conceptual diagram illustrating a distributed resource allocation process in a traffic transmission/reception process according to an embodiment of the present invention;

FIG. 8 is a conceptual diagram illustrating a reception abandonment condition in a traffic transmission/reception process according to an embodiment of the present invention;

FIG. 9 is a conceptual diagram illustrating connection scheduling in a traffic transmission/reception process according to an embodiment of the present invention;

FIG. 10 is a conceptual diagram illustrating signal to interference ratio (SIR) measurement for each subcarrier in a traffic transmission/reception process according to an embodiment of the present invention;

FIG. 11 is a conceptual diagram illustrating measurement of a reception abandonment condition using a request to send (RTS) in a traffic transmission/reception process according to an embodiment of the present invention;

FIG. 12 is a conceptual diagram illustrating measurement of a transmission abandonment condition using a clear to send (CTS) in a traffic transmission/reception process according to an embodiment of the present invention;

FIG. 13 is a flowchart illustrating a traffic transmission/reception process according to an embodiment of the present invention; and

FIG. 14 is a conceptual diagram illustrating a paging and connection scheduling process according to an embodiment of the present invention.

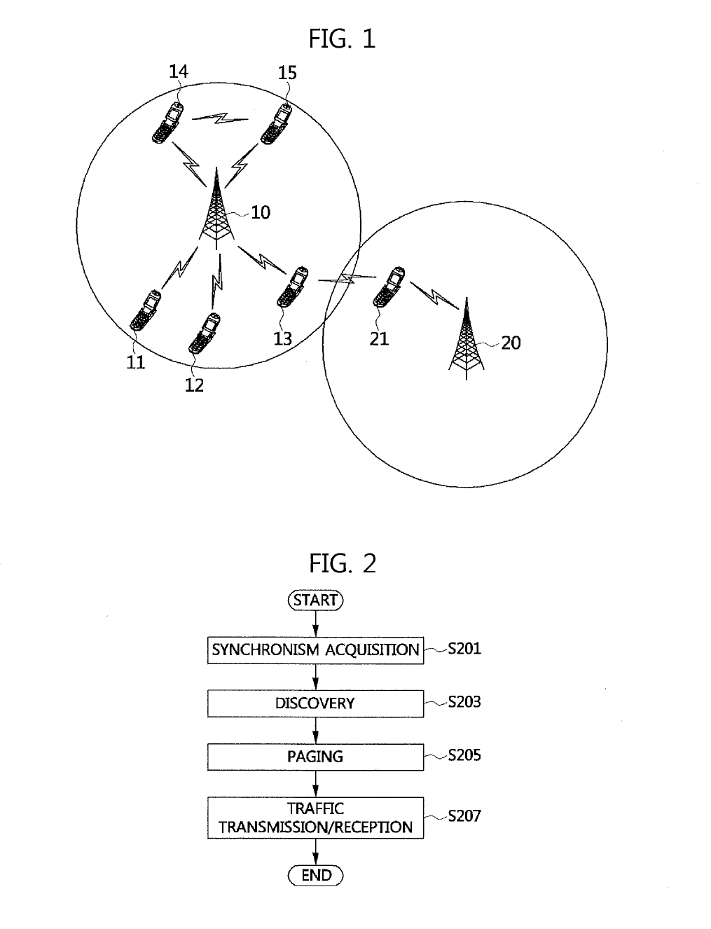

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relations between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

It should also be noted that in some alternative implementations, operations may be performed out of the sequences depicted in the flowcharts. For example, two operations shown in the drawings to be performed in succession may in fact be executed substantially concurrently or even in reverse of the order shown, depending upon the functionality/acts involved.

A “terminal” used in the present specification may refer to a device, a mobile station (MS), user equipment (UE), a user terminal (UT), a wireless terminal, an access terminal (AT), a terminal, a subscriber unit, a subscriber station (SS), a wireless device, a wireless communication device, a wireless transmission/reception unit (WTRU), a mobile node, a mobile, or other terminologies. A variety of embodiments of the terminal may include a cellular phone, a smart phone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storage and reproduction appliance having a wireless communication function, an Internet appliance enabling wireless Internet connection and browsing, and a portable unit or terminal in which combinations of the above described functions are integrated, but is not limited thereto.

Hereinafter, preferred embodiments of the present invention will be described in detail with reference to the accompanying drawings. Throughout the accompanying drawings, the same reference numerals are used to designate the same or similar components, and redundant descriptions thereof are omitted for easier overall understanding.

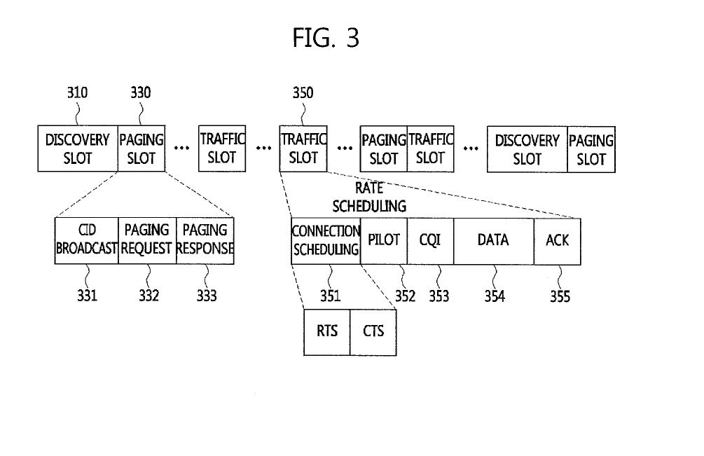

FIG. 2 is a flowchart illustrating a connection setting process for D2D communication, and FIG. 3 is a drawing illustrating a structure of a frame that is used in a D2D communication process.

Referring to FIGS. 2 and 3, in step S201, when power is applied to a terminal desiring to perform device to device (D2D) communication, the terminal acquires time synchronism.

It is assumed that all terminals in the D2D communication have the same time standard. For synchronism acquisition, the terminal may use a variety of means such as synchronization signals transmitted by a base station of the Global Positioning System (GPS) or an existing cellular system.

In step S203, after acquiring the synchronism, each terminal notifies adjacent terminals of its own presence, and performs a discovery process for recognizing the presence of the adjacent terminals. Here, the terminal broadcasts its own identification (ID) using a discovery slot 310 to thereby notify the adjacent terminals of its own presence, and receives broadcast IDs from the adjacent terminals to thereby recognize the presence of the adjacent terminals. Each terminal may acquire an ID list of the adjacent terminals based on the ID of each terminal received from the adjacent terminals in the discovery process.

When the discovery process is completed, the terminal may set connection with a specific adjacent terminal. A process of setting connection for D2D communication between two adjacent terminals may be referred to as a paging process S205, and in the paging process, a paging slot 330 is used. When the paging process is completed, a connection ID (CID) that is an ID for identifying connection of two terminals desiring D2D communication is generated.

Next, in step S207, the two terminals occupy frequency and time resources using a distributed algorithm for efficiently reusing wireless resources while avoiding collision therebetween, and perform a traffic transmission/reception process for exchanging information therebetween using the occupied wireless resources. In the traffic transmission/reception process, a traffic slot 350 is used.

Meanwhile, the paging process S205 shown in FIG. 2 includes a CID broadcast process and a paging request and paging response process, and the CID broadcast, the paging request, and the paging response respectively use a CID broadcast slot 331, a paging request slot 332, and a paging response slot 333 of the paging slot 330 which are shown in FIG. 3.

In addition, the traffic transmission/reception process S207 shown in FIG. 2 includes a connection scheduling process, a pilot transmission process, a channel quality indication (CQI) reception process, and a data and acknowledgment (ACK) process, and the connection scheduling process, the pilot transmission process, the CQI reception process, and the data and ACK process respectively use a connection scheduling slot 351, a pilot slot 352, a CQI slot 353, a data slot 354, and an ACK slot 355 of the traffic slot shown in FIG. 3. Here, a combination of the pilot transmission process and the CQI reception process may be referred to as rate scheduling. The connection scheduling process includes a request to send (RTS) transmission process and a clear to send (CTS) reception process.

Meanwhile, in the D2D communication connection setting process, in the related art, a single-tone signaling method has been used in the connection scheduling process of the paging process S205 and the traffic transmission/reception process S207, and a terminal to which resources are allocated through the connection scheduling process transmits information using overall wireless resources (for example, overall subcarriers).

When the single-tone signaling is used, a reception terminal may measure power using the CID broadcast of the paging process and a single subcarrier in the paging request and paging response process. However, in a frequency selective channel environment, a channel that is applied to a single specific subcarrier (or single tone) does not represent the entire channel, and therefore use of the single-tone signaling may cause a reduction in a performance in the frequency selective channel environment.

In addition, an RTS signal and a CTS signal of the connection scheduling process use a single subcarrier in the existing D2D communication connection setting process, and therefore transmission and reception abandonment conditions of a corresponding terminal may be erroneously determined, and this may cause collision in a data transmission process. In the D2D communication method according to an embodiment of the present invention, a performance of a wireless link may be improved by transmitting a sequence in a broadband in the paging and connection scheduling process in order to solve the above-described problems, and usage efficiency of the wireless resources may be improved.

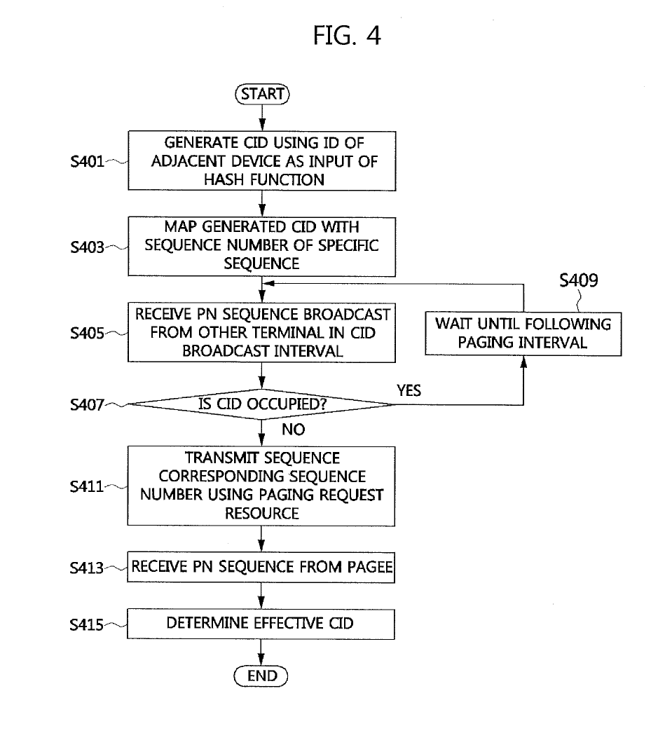

FIG. 4 is a flowchart illustrating a paging process of a D2D communication method according to an embodiment of the present invention.

When the discovery process is completed, a terminal may acquire IDs of other terminals located in the vicinity of the terminal, and set connection for D2D communication using IDs of adjacent terminals. Here, a unique identifier (ID) for indicating D2D communication connection between two terminals is required, and such a unique ID may be referred to as a CID. Meanwhile, a terminal that requests paging from among two terminals desiring D2D communication connection may be referred to as a pager, and a terminal that responds to the paging request of the pager may be referred to as a pagee.

In step S401, a pager terminal may generate a CID using an ID of a terminal desiring D2D communication connection as an input of a hash function from the list of the adjacent terminals acquired through the discovery process. Here, the generated CID may denote a result value of the hash function.

Next, in step S403, the pager terminal may one-to-one map a sequence number indicating a specific pseudo noise (PN) sequence that is an element of a PN sequence set including a plurality of PN sequences which are set in advance, and the generated CID. Here, the PN sequence may denote all kinds of sequences which can be divided by performing a signal process with respect to the signals received by the reception terminal.

Meanwhile, the pager terminal may not request the paging using the generated CID immediately after generating the CID using the hash function, and should determine whether another terminal using the same CID as the generated CID of the pager terminal is present.

Accordingly, all terminals that have acquired the CID in advance should broadcast, to other terminals, the fact that a specific CID is used by each of the terminals using resources allocated for the purpose of CID broadcast.

In step S405, the pager terminal transmits the PN sequence mapped with the CID in a CID broadcast interval using the resources allocated for the purpose of CID broadcast, and receives a PN sequence corresponding to a CID of each terminal broadcast from the other terminals.

Next, in step S407, the pager terminal determines whether the CID generated by the pager terminal is occupied based on the PN sequence received from the other terminals. Here, the pager terminal determines that the CID generated by the pager terminal is already occupied by another terminal and cannot be used when a reception signal level of the PN sequence corresponding to the CID generated by the pager terminal among the PN sequences received from the other terminals in the CID broadcast interval is equal to or larger than a predetermined reference level, waits until the following paging interval, and then performs step S405.

Alternatively, when the reception signal level of the PN sequence corresponding to the CID generated by the pager terminal among the PN sequences received from the other terminals in the CID broadcast interval is less than the predetermined reference level, or the PN sequence corresponding to the CID generated by the pager terminal is not received, the pager terminal determines that the CID generated by the pager terminal is not occupied, and performs a paging request for requesting D2D communication connection from the pager using the generated CID. Here, in step S411, the pager terminal transmits the PN sequence corresponding to the sequence number using a plurality of subcarriers for a paging request. In a paging request interval, a plurality of pagers are not simultaneously used, but in the present invention, the paging request is transmitted using the PN sequence, and therefore the pagee terminal may divide the paging request signal received from a plurality of terminals using correlation characteristics to thereby determine whether the pager terminal is called.

Meanwhile, terminals positioned in the vicinity of the pager terminal may measure reception power of the PN sequence corresponding to a CID of each of the terminals in the paging request interval in order to determine whether each of the terminals is called from another terminal, and determine that each of the terminals is called when the measured power is equal to or larger than a predetermined threshold value.

The called terminal transmits the PN sequence corresponding to a CID of the called terminal using subcarriers allocated to the paging response interval. Here, the pager terminal and the pagee terminal use the same CID to thereby use the same PN sequence.

Meanwhile, in step S415, the pager terminal measures reception power of the PN sequence corresponding to the CID generated by the pager terminal in the paging response interval, and then determines that the paging response is received when the measured power is equal to or larger than a predetermined threshold value. That is, when receiving the paging response from the pagee terminal, the pager terminal determines that the CID generated by the pager terminal is available, and then uses the CID in the traffic transmission/reception process thereafter.

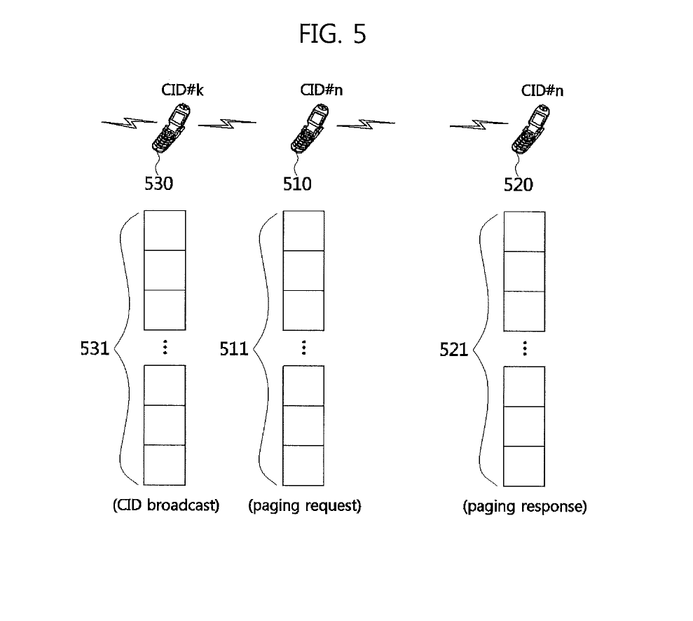

FIG. 5 is a conceptual diagram illustrating the paging process shown in FIG. 4.

In FIG. 5, in a network environment in which a pager terminal 510, a pagee terminal 520, and an adjacent terminal 530 are positioned within a range enabling D2D communication with each other, a case in which the pager terminal 510 performs paging in order to perform D2D communication with the pagee terminal 520 is illustrated.

The pager terminal 510 determines the pagee terminal 520 as a D2D communication target terminal from an ID list of adjacent terminals obtained after performing the discovery process, and generates CID#n using an ID of the pagee terminal 520 as an input of a hash function.

In addition, the pager terminal 510 maps the generated CID#n and a sequence number, and transmits a paging request signal using the PN sequence corresponding to the mapped sequence number.

Meanwhile, the pager terminal 510 receives the PN sequence broadcast using a plurality of subcarriers 531 from an adjacent terminal 530 in a CID broadcast interval, and determines that the CID#n generated by the pager terminal 510 is not occupied. Here, the PN sequence received from the adjacent terminal 530 is a sequence mapped in CID#k that is a CID value of the adjacent terminal 530, and therefore the pager terminal 510 may determine that the CID#n generated by the pager terminal 510 is different from the CID#k generated by the adjacent terminal based on the PN sequence received from the adjacent terminal 530.

Thereafter, the pager terminal 510 maps the PN sequence corresponding to the CID#n of the pager terminal 510 in a plurality of subcarriers 511 allocated for paging request, and then transmits the mapped PN sequence.

The pagee terminal 520 receives a paging request signal including the PN sequence transmitted from the pager terminal 510 in the paging request interval, and measures reception power of the PN sequence corresponding to the pagee terminal 520. Here, when reception power of the PN sequence corresponding to the PN sequence of the pagee terminal 520 is determined to be equal to or larger than a threshold value, the pagee terminal 520 maps the PN sequence corresponding to the CID#n of the pagee terminal 520 in a plurality of subcarriers 521 for paging response, and transmits the mapped PN sequence.

The pager terminal 510 receives a paging response signal in the paging response interval, and determines whether reception power of the PN sequence corresponding to the CID#n of the pager terminal 510 is equal to or larger than a predetermined threshold value. Here, when the reception power of the PN sequence received by the pager terminal 510 is equal to or larger than the threshold value, the CID#n is determined as the CID indicating D2D communication connection of the pager terminal 510 and the pagee terminal 520.

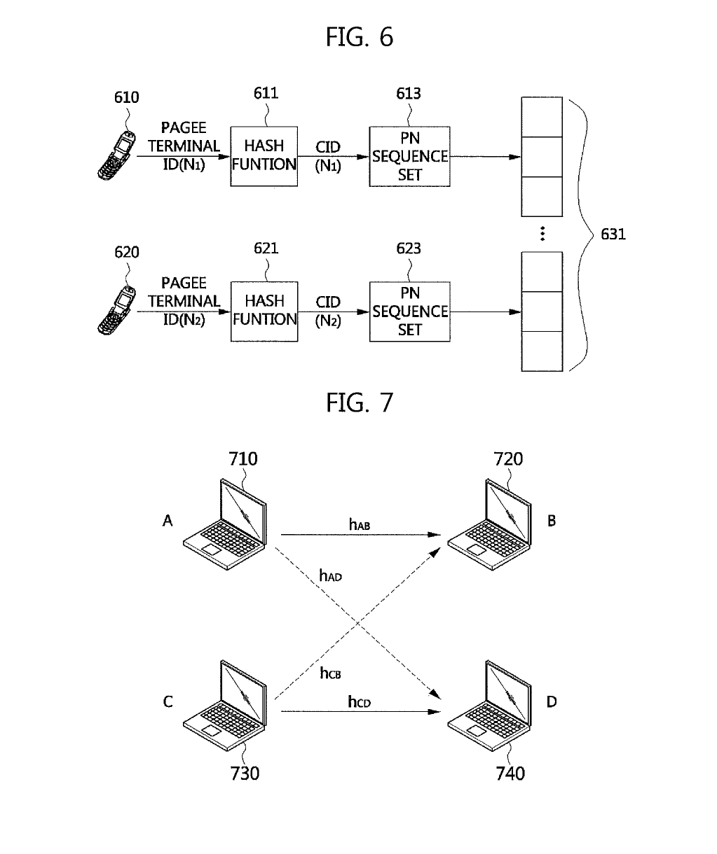

FIG. 6 is a conceptual diagram illustrating CID generation and PN sequence mapping of a paging process according to an embodiment of the present invention.

Referring to FIG. 6, a pager terminal 610 generates CID(n₁) as an output value of a hash function 611 using ID(N₁) of an adjacent terminal (a predetermined pagee terminal) desiring D2D communication connection as an input of the hash function 611.

Thereafter, the pager terminal 610 selects a specific sequence number corresponding to the CID(n₁) generated in a PN sequence set 613 including PN sequences, and therefore the generated CID(n₁) may be one-to-one mapped with the PN sequence of the selected sequence number. The pager terminal 610 maps the selected PN sequence in a plurality of subcarriers 631 constituting a paging request interval, and then transmits the mapped PN sequence.

Meanwhile, the pager terminal 620 generates CID(n₂) as an output value of a hash function 621 using ID(N₂) of an adjacent terminal (a predetermined pagee terminal) desiring D2D communication connection as an input of the hash function 621. Thereafter, the pager terminal 620 selects a specific PN sequence number corresponding to the CID(n₂) generated in a PN sequence set 623 including PN sequences, and therefore the generated CID(n₁) may be one-to-one mapped with the PN sequence of the selected sequence number. Here, the PN sequence set 613 and the PN sequence set 623 may include the same PN sequences, and each of the PN sequences included in each PN sequence set may the same sequence number. The pager terminal 620 maps the selected PN sequence in a plurality of subcarriers 631 constituting a paging request interval, and then transmits the mapped PN sequence.

As shown in FIG. 6, the plurality of subcarriers 631 constituting the paging request interval may be resources simultaneously used by a plurality of pager terminals, but each pagee terminal may be aware of a corresponding PN sequence number corresponding to the ID of the pagee terminal, and therefore the pagee terminal may divide overlapped signals received using the PN sequence number (or PN sequence) of the pagee terminal to thereby determine whether the pagee terminal is called.

As described above, in the paging process for D2D communication according to an embodiment of the present invention, the PN sequence corresponding to the CID generated by each pager terminal may be mapped in a plurality of subcarriers constituting the paging request interval, and therefore performance deterioration of the paging request occurring due to frequency selective characteristics of the channel may be improved. In addition, in the same manner, a CID broadcast and paging response performance may be improved.

Hereinafter, the traffic transmission/reception process of the D2D communication method according to an embodiment of the present invention will be described in detail.

As described above, a traffic transmission/reception interval may include a connection scheduling interval, a pilot interval, a CQI interval, and a data and ACK interval.

The connection scheduling interval is a process in which resources are occupied in a distributed method without centralized control while maximizing spatial reuse efficiency of wireless resources without terminals causing interference with each other through RTS and CTS signal exchange.

The pilot and CQI intervals are rate scheduling intervals, and a transmission terminal occupying wireless resources in a distributed method through the connection scheduling process transmits a pilot signal. A reception terminal receiving the pilot signal measures a channel based on the pilot signal, and then transmits an adaptive modulation and coding (AMC) level (that is, CQI) to the transmission terminal based on the measured channel. The transmission terminal may perform AMC using the received CQI to thereby transmit data, and the reception terminal may transmit ACK to the transmission terminal to correspond to the received data.

In the traffic transmission/reception process for D2D communication as described above, it is important to efficiently occupy and release resources in a distributed method without centralized control.

FIG. 7 is a conceptual diagram illustrating a distributed resource allocation process in a traffic transmission/reception process according to an embodiment of the present invention.

In FIG. 7, an example of a D2D communication environment in which a terminal A 710 and a terminal B 720 perform D2D communication connection and a terminal C 730 and a terminal D 740 perform D2D communication connection is illustrated.

In the D2D communication environment shown in FIG. 7, a direct gain {|h_{AB}|², |h_{CD}|²} between a terminal A 710 and a terminal B 720, and between a terminal C 730 and a terminal D 740, and a cross-link gain {|h_{AD}|², |h_{CB}|²} between the terminal A 710 and the terminal D 740, and between the terminal C 730 and the terminal D 740 may be considered.

Here, when the cross-link gain is sufficiently small, two links may be simultaneously set in the same channel, but otherwise, resources may not be allocated to one of the two links.

Accordingly, when the cross-link gain is not sufficiently small, resources should be first allocated to a link having a high priority, and resources should be allocated to another link having a low priority only when it does not cause large interference to the link having a high priority.

When it is assumed that a link (link AB) between the terminal A 710 and the terminal B 720 has a higher priority than a link (link CD) between the terminal C 730 and the terminal D 740, a method in which the link AB is protected by preventing the terminal C 730 of the link CD from arbitrarily transmitting a signal is needed.

In a case in which the terminal C 730 transmits a signal, when an SIR exerted on the terminal B 720 of the link AB is known, the link AB having a high priority may be protected.

Accordingly, a condition such as Equation 1 for protecting the link AB having a high priority from the point of view of the terminal C 730 is required, and this is referred to as a transmission abandonment condition.

$$SIR = \frac{{P}_{A} {\vert {h}_{AB} \vert}^{2}}{{P}_{C} {\vert {h}_{CB} \vert}^{2}} > {γ}_{TX} dB \qquad [ Equation 1 ]$$

In Equation 1, P_{A} denotes transmission power of the terminal A 710 and P_{c} denotes transmission power of the terminal C 730. In addition, |h_{AB}|² denotes a channel gain between the terminal A 710 and the terminal B 720, and |h_{CB}|² denotes a channel gain between the terminal C 730 and the terminal B 720. In addition, γ_{TX} denotes a predetermined transmission SIR reference value. That is, when the measured SIR is larger than γ_{TX}, the terminal C 730 may transmit a signal.

However, two links may not be simultaneously scheduled using only the transmission abandonment condition as shown in Equation 1 in accordance with a disposition environment of terminals.

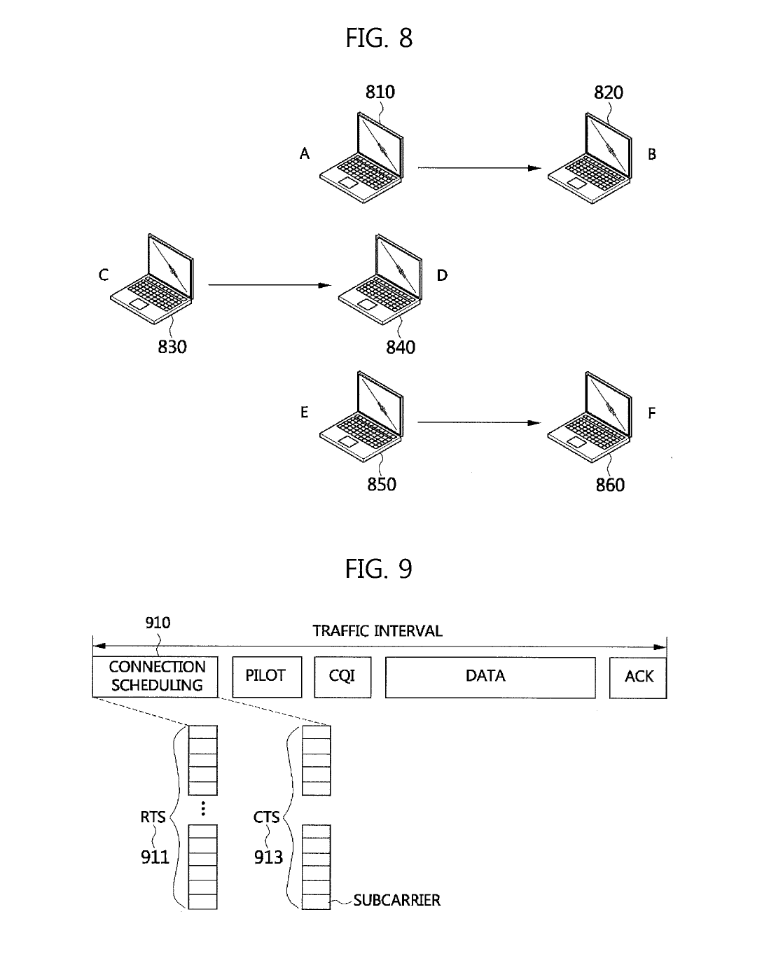

FIG. 8 is a conceptual diagram illustrating a reception abandonment condition in a traffic transmission/reception process according to an embodiment of the present invention.

In a communication environment in which a terminal A 810 and a terminal D 840 are adjacent to each other even though a link CD of a terminal C 830 and a terminal D 840 sufficiently protects the link AB as shown in FIG. 8, the terminal D 840 may not receive a signal transmitted from the terminal C 830 normally due to interference of the signal transmitted by the terminal A 81 even when the terminal C 830 has transmitted a signal to the terminal D 84.

In this case, when the terminal C 830 does not transmit the signal, interference on a link EF of a terminal E 850 and a terminal F 860 is actually mitigated to thereby improve efficiency of the entire network. That is, when the terminal D 840 ascertains the interference of the terminal A 810 to thereby utilize the ascertained interference in scheduling, the efficiency of the network may be improved.

Accordingly, from the point of view of the terminal D 840, a condition such as Equation 2 is additionally required, and this refers to as a reception abandonment condition.

$$SIR = \frac{{P}_{C} {\vert {h}_{CD} \vert}^{2}}{{P}_{A} {\vert {h}_{AD} \vert}^{2}} > {γ}_{RX} dB \qquad [ Equation 2 ]$$

In Equation 2, P_{A} denotes transmission power of the terminal A 810 and P_{c} denotes transmission power of the terminal C 830. In addition, |h_{AD}|² denotes a channel gain between the terminal A 810 and the terminal D 840, and |h_{CD}∥² denotes a channel gain between the terminal C 830 and the terminal D 840. In addition, γ_{RX} denotes a predetermined reception SIR reference value.

That is, the terminal C 830 may receive a signal when the measured SIR is larger than γ_{RX}.

FIG. 9 is a conceptual diagram illustrating connection scheduling in a traffic transmission/reception process according to an embodiment of the present invention.

A connection scheduling interval 910 shown in FIG. 9 includes an RTS interval 911 and a CTS interval 913. A pagee terminal maps a sequence designed so as to measure an SIR for each subcarrier in subcarriers allocated to RTS resources, and then transmits the mapped sequence. For this, a pager terminal may use a variety of sequences such as PN, Cyclic shifted Zadoff-Chu (ZC), or the like, but hereinafter, a Cyclic shifted ZC sequence will be described.

A CID generated by a transmission terminal (or a pager terminal) and a specific sequence may be one-to-one mapped. Sequence division may be performed using sequence numbers, and a sequence used by a transmission/reception terminal pair may be the same. In addition, a priority of a link may be set in accordance with the sequence number, and in an embodiment of the present invention, a link having a lower sequence number is defined as a link having a higher priority.

When a length of a cyclic shift is longer than that of a channel impulse response, a reception terminal may enable channel estimation for each terminal and for each subcarrier even when a plurality of transmission terminals transmit the same ZC sequence using the same RTS resource having different cyclic shifts, and therefore the reception terminal may measure an SIR for each transmission terminal and for each subcarrier.

For example, when it is assumed that a length of an OFDM symbol in an OFDMA is to Tₚ and a maximum impulse response length of a channel is T_{CS},

$$⌊ \frac{{T}_{p}}{{T}_{CS}} ⌋$$

transmission terminals may transmit the same ZC sequence having different cyclic shifts using the same resource, and the reception terminal may divide the channels experienced by overall subcarriers constituting the OFDM symbol for each transmission terminal to thereby accurately measure the divided channels. In this case, when the number of CIDs participating in the connection scheduling is larger than

$$⌊ \frac{{T}_{p}}{{T}_{CS}} ⌋ ,$$

a problem may occur. However, a probability that the number of CIDs simultaneously participating in the connection and scheduling is larger than

$$⌊ \frac{{T}_{p}}{{T}_{CS}} ⌋$$

may be significantly small.

When a value of

$$⌊ \frac{{T}_{p}}{{T}_{CS}} ⌋$$

is smaller than a desired value, a ZC sequence having a different base may be additionally used.

In the above-described manner, the reception terminal may measure the channel for each transmission terminal and for each subcarrier, and thereby may measure an SIR for each subcarrier.

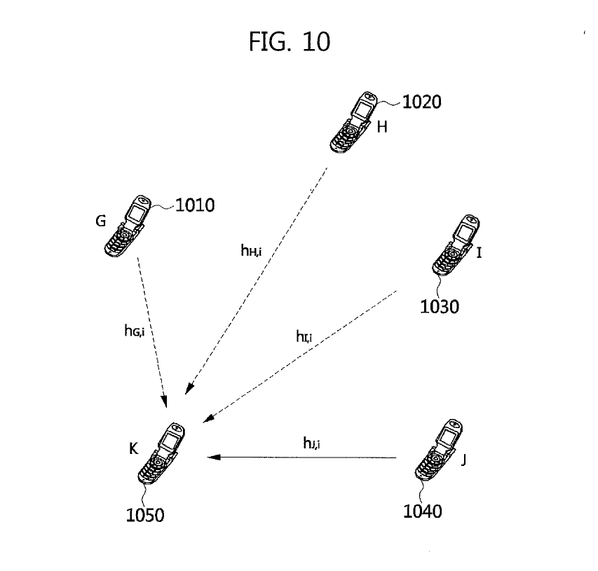

FIG. 10 is a conceptual diagram illustrating signal to interference ratio (SIR) measurement for each subcarrier in a traffic transmission/reception process according to an embodiment of the present invention.

Referring to FIG. 10, when four terminals G, H, I, and J 1010, 1020, 1030, and 1040 transmit a ZC sequence having mutually different cyclic shifts using subcarriers allocated to an RTS interval, a reception terminal K 1050 may divide channels for each transmission terminal and for each subcarrier to thereby measure the divided channels. For example, in a D2D communication link including a terminal J 1040 and a terminal K 1050, an SIR of an i^{th} subcarrier may be obtained using Equation 3.

$${SIR}_{i} = \frac{{\vert {h}_{J , i} \vert}^{2}}{{\vert {h}_{G , i} \vert}^{2} + {\vert {h}_{H , i} \vert}^{2} + {\vert {h}_{I , i} \vert}^{2}} \qquad [ Equation 3 ]$$

However, an SIR of any one subcarrier calculated through Equation 3 may not represent an SIR of the entire broadband channel including a plurality of subcarriers. Accordingly, a method of obtaining an SIR capable of representing a channel including a plurality of subcarriers is required. Hereinafter, a representative SIR of the channel including the plurality of subcarriers is referred to as an effective SIR(SIR_{eff}).

As examples of a method of obtaining the effective SIR(SIR_{eff}), a quasi-static method, a convex method, a Shannon method, an exponential effective SIR mapping (EESM) method, and the like may be given. The effective SIR may be represented by Equation 4 using a function value having each subcarrier SIR as an input.

SIR_{eff}=f(SIR₁,SIR₂, . . . ,SIR_{N}) [Equation 4]

In Equation 4, SIR₁ denotes an SIR of an i^{th} subcarrier among N subcarriers.

The transmission abandonment condition of Equation 1 and the reception abandonment condition of Equation 2 which are described in an embodiment of the present invention use all the effective SIR measured using Equation 4.

Since the effective SIR is an SIR representing all subcarriers constituting the channel transmitting data rather than an SIR of any one subcarrier, an accurate SIR may be provided in a frequency selective channel environment, and therefore reliability with respect to determination of the transmission and reception abandonment conditions may be ensured. In addition, in an embodiment of the present invention, it is assumed that the sequence number indicates the priority, and therefore each terminal may divide a link having a higher priority than its own priority.

Hereinafter, a distributed scheduling process of the D2D communication method according to an embodiment of the present invention will be described in more detail.

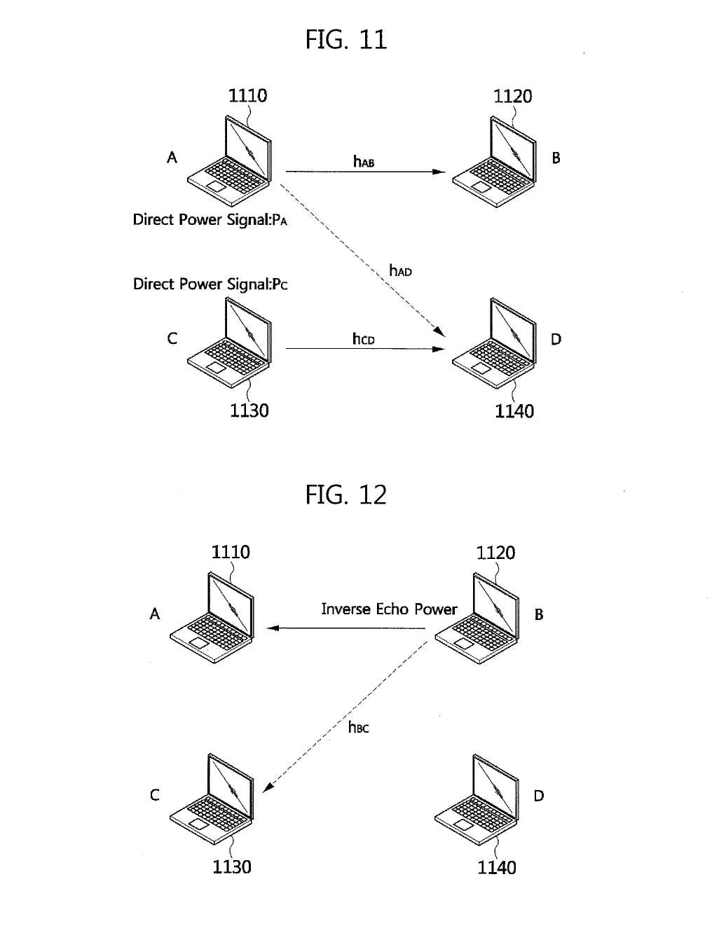

FIG. 11 is a conceptual diagram illustrating measurement of a reception abandonment condition using an RTS in a traffic transmission/reception process according to an embodiment of the present invention, and FIG. 12 is a conceptual diagram illustrating measurement of a transmission abandonment condition using a CTS in a traffic transmission/reception process according to an embodiment of the present invention.

Referring to FIGS. 11 and 12, in an environment in which a terminal A 1110 and a terminal B 1120 form a link AB, and a terminal C 1130 and a terminal D 1140 form a link CD, the reception terminal D 1140 may test a reception abandonment condition using an RTS signal (that is, a sequence transmitting the RTS signal using an RTS resource) transmitted by the terminal A 1110 having a higher priority than the reception terminal D 1140.

When reception is determined as being impossible due to interference caused by the link AB having a higher priority than that of the reception terminal D 1140 based on the test result of the reception abandonment condition, the reception terminal D 1140 abandons CTS transmission and waits for the following traffic slot, and then performs the same attempt in the following traffic slot. Here, the RTS signals transmitted from the terminal A 1110 and the terminal C 1130 are transmitted to a direct power level to thereby support measurement of the reception abandonment condition by the reception terminal D 1140.

Meanwhile, as shown in FIG. 12, when the terminal B 1120 satisfies the reception abandonment condition due to sufficiently high effective SIR, the reception terminal B 1120 transmits a sequence using inverse echo power through a subcarrier allocated to a CTS region to thereby transmit a response (CTS) with respect to the RTS to the transmission terminal A 1110 having the same CID, and supports measurement of the transmission abandonment condition by the transmission terminal C 1130 having a low priority. In this case, the reception terminal B 1120 may use a ZC sequence having the same cyclic shift as that of the transmission terminal A 1110 having the same CID.

That is, when the terminal B 1120 transmits power of K/P_{A}|h_{AB}|² (here, K is a constant value) that is inverse echo power of the direct power transmitted from the terminal A 1110, the terminal having a low priority may receive power of K|h_{BC}|²/P_{A}|h_{AB}|². Here, K and P_{C} are values known to the terminal C 1130, and therefore the terminal C 1130 may measure the transmission abandonment condition.

When the effective SIR that is the transmission abandonment condition is not sufficiently high, the terminal C 1130 may not perform further procedures for being allocated resources.

As described above, the transmission abandonment condition and the reception abandonment condition may realize distributed resource allocation enabling recycle of wireless resources in accordance with spatial distribution without causing communication failure due to interference to terminals having a higher priority.

When the transmission abandonment condition and the reception abandonment condition are both satisfied, a transmission terminal (a pager terminal) and a reception terminal (a pagee terminal) may use resources in a current traffic slot.

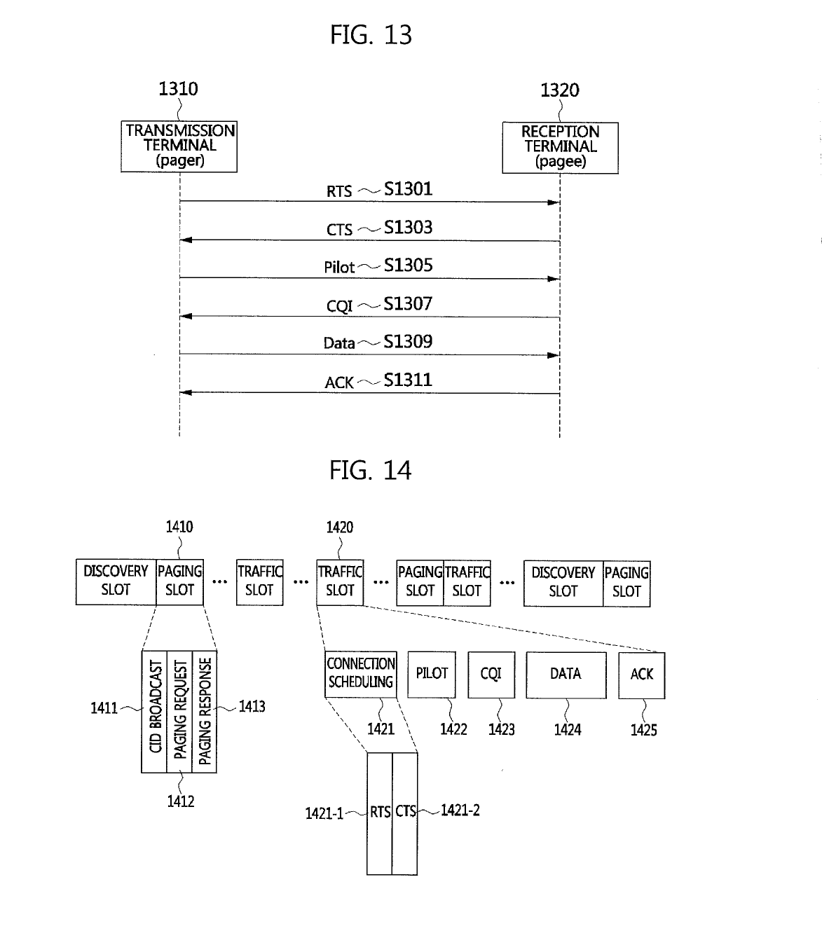

FIG. 13 is a flowchart illustrating a traffic transmission/reception process according to an embodiment of the present invention.

Referring to FIG. 13, a transmission terminal 1310 transmits an RTS signal to a reception terminal 1320 in step S1301, and the reception terminal 1320 determines a reception abandonment condition based on the RTS signal transmitted from the transmission terminal 1310. When the reception abandonment condition is satisfied, the reception terminal 1320 transmits a CTS signal to the transmission terminal 1310, and the transmission terminal 1310 determines the transmission abandonment condition based on the CTS signal received from the reception terminal 1320.

When the transmission abandonment condition is satisfied, the transmission terminal 1310 transmits a pilot signal in step S1305 so that the reception terminal 1320 measures a channel to determine an AMC. When a CQI is received from the reception terminal 1320 in step S1307, the transmission terminal 1310 transmits data in step S1309. Here, the transmission terminal 1310 may not continuously use resources in the following data slot even when the transmission terminal 1310 occupies a data slot once, and when the data slot is required to be used, the same procedure may be repeated for each data slot.

The reception terminal 1320 transmits an ACK to the transmission terminal 1310 to correspond to the data received from the transmission terminal 1310, and the transmission terminal 1310 receives the transmitted ACK signal from the reception terminal 1320 in step S1311.

Meanwhile, in a traffic transmission/reception procedure shown in FIG. 13, the reception terminal 1320 may measure reception power of a pilot signal transmitted by the transmission terminal 1310 to thereby obtain a test result of the transmission abandonment condition of the transmission terminal 1310. That is, when the reception power of the received pilot signal is equal to or larger than a predetermined value, the reception terminal 1320 may continuously perform further procedures, and when the reception power of the pilot signal is less than the predetermined value, the reception terminal 1320 may not transmit a CQI.

Here, when a PN sequence that is one-to-one mapped with the CID is used as the pilot signal, the reception terminal 1320 may more accurately measure a corresponding pilot signal using a correlation function, and thereby may more accurately deduce the test result of the transmission abandonment condition of the transmission terminal 1310.

FIG. 14 is a conceptual diagram illustrating a paging and connection scheduling process according to an embodiment of the present invention.

First, a paging process 1410 includes a CID broadcast interval 1411, a paging request interval 1412, and a paging response interval 1413, and in the CID broadcast interval 1411, the paging request interval 1412, and the paging response interval 1413, a plurality of subcarriers may be used. Here, a plurality of sequences are mapped in the same resource including the plurality of subcarriers to thereby be simultaneously transmitted. Accordingly, a plurality of terminals may simultaneously use the same resource.

Specifically, a transmission terminal generates a CID using an ID of a reception terminal desiring to set D2D connection as an input of a hash function, and selects a PN sequence one-to-one mapped in the generated CID. Meanwhile, all terminals using the CID should transmit a PN sequence corresponding to the used CID using a CID broadcast resource.

A transmission terminal receives the PN sequence transmitted from another terminal in the CID broadcast interval 1411, and determines whether the CID generated by the transmission terminal is occupied based on the received PN sequence.

When the CID generated by the transmission terminal is not occupied, the transmission terminal transmits the PN sequence using a paging request resource including a plurality of subcarriers. Here, the paging request interval 1412 may be used in a CDMA scheme, and therefore a plurality of transmission terminals may simultaneously use the same paging request interval.

The reception terminal determines whether the reception terminal is called in the paging request interval 1412, and transmits the same PN sequence as that of the transmission terminal to the transmission terminal using a paging response resource when the reception terminal is determined as being called. The transmission terminal receives the PN sequence transmitted from the reception terminal in the paging response interval 1413.

A traffic transmission/reception process 1420 includes a connection scheduling interval 1421, a pilot interval 1422, a CQI interval 1423, a data interval 1424, and an ACK interval 1425.

The connection scheduling interval 1421 includes an RTS interval 1421-1 and a CTS interval 1421-2.

In the RTS interval 1421-1, a sequence corresponding to a CID is mapped in the RTS interval including a plurality of subcarriers to thereby be transmitted. Here, a ZC sequence to which a cyclic shift is applied is significantly useful for channel estimation, and therefore, the reception terminal may divide channels for each subcarrier and for each transmission terminal to thereby measure the divided channels even when a plurality of terminals simultaneously transmit the same ZC sequence that is cyclic-shifted in a mutually different manner, in the RTS interval.

Meanwhile, when the reception abandonment condition shown in Equation 2 is satisfied, the reception terminal transmits the cyclic-shifted ZC sequence corresponding to its own CID using resources of the CTS interval 1421-2.

The transmission terminal may measure the cyclic-shifted ZC transmitted by the reception terminal using the CTS 1421-2 interval by dividing the channels for each subcarrier and for each terminal, calculate an effective SIR using Equation 4 from the SIR values measured for each subcarrier, and determine whether the following step is performed.

When the calculated effective SIR value satisfies the transmission abandonment condition, the transmission terminal transmits a pilot signal in the pilot interval 1422.

Thereafter, when receiving the CQI interval 1423 from the reception terminal as a response of the pilot signal, the transmission terminal transmits the data interval 1424, and receives, from the reception terminal, a signal of an ACK interval 1425 as a response of the data transmission.

While the example embodiments of the present invention and their advantages have been described in detail, it should be understood that various changes, substitutions and alterations may be made herein without departing from the scope of the invention.

What is claimed is:

1. A device to device (D2D) communication method comprising:
generating a connection identification (CID) for D2D communication using an identification (ID) of a specific terminal;
selecting a sequence corresponding to the CID; and
transmitting the selected sequence using a paging request resource including a plurality of subcarriers.

2. The D2D communication method of claim 1, wherein the generating of the CID includes generating the CID as an output of a hash function using the ID of the specific terminal as an input of the hash function.

3. The D2D communication method of claim 1, wherein the selecting of the sequence includes selecting the sequence corresponding to the CID from a sequence set including a plurality of pseudo noise (PN) sequences which are set in advance.

4. The D2D communication method of claim 1, further comprising, after the selecting:
receiving at least one sequence broadcast from other terminals; and
determining whether the generated CID is occupied based on the received at least one sequence.

5. The D2D communication method of claim 4, wherein the transmitting of the selected sequence includes waiting until the following paging interval when the generated CID is occupied by the other terminal, and then transmitting the selected sequence using the paging request resource when the generated CID is not occupied in the following paging interval.

6. The D2D communication method of claim 1, further comprising, after the transmitting:
receiving at least one sequence transmitted from at least one other terminal in a paging response interval;
measuring reception power of the sequence corresponding to the generated CID among the received at least one sequence; and
determining that a paging response is received when the measured reception power is equal to or larger than a predetermined threshold value.

7. A D2D communication method which is performed in a transmission terminal requesting D2D communication connection, the D2D communication method comprising:
transmitting a request to send (RTS) signal by mapping a sequence corresponding to a generated CID in an RTS resource including a plurality of subcarriers;
determining whether a transmission abandonment condition is satisfied based on a clear to send (CTS) signal received from a reception terminal; and
transmitting a pilot signal when the transmission abandonment condition is satisfied.

8. The D2D communication method of claim 7, wherein the determining includes:
receiving a sequence mapped in a plurality of subcarriers as the CTS signal;
measuring a channel quality based on all of the plurality of subcarriers; and
determining that the transmission abandonment condition is satisfied when the measured channel quality is equal to or larger than a predetermined threshold value.

9. The D2D communication method of claim 8, wherein the measuring of the channel quality includes measuring an effective signal to interference ratio (SIR) representing an SIR of each of the plurality of subcarriers.

10. The D2D communication method of claim 7, wherein the transmitting of the pilot signal includes transmitting the sequence corresponding to the CID as the pilot signal.

11. A D2D communication method which is performed in a reception terminal receiving a request for D2D communication connection, the D2D communication method comprising:
receiving an RTS signal;
determining whether a reception abandonment condition is satisfied based on the received RTS signal; and
transmitting a CTS signal by mapping a sequence corresponding to a generated CID in a plurality of subcarriers when the reception abandonment condition is satisfied.

12. The D2D communication method of claim 11, wherein the determining includes:
measuring a channel quality based on all of the plurality of subcarriers constituting the received RTS signal; and
determining that the reception abandonment condition is satisfied when the measured channel quality is equal to or larger than a predetermined threshold value.

13. The D2D communication method of claim 12, wherein the measuring of the channel quality includes measuring an effective SIR representing an SIR of each of the plurality of subcarriers.

14. The D2D communication method of claim 11, further comprising, after the transmitting of the CTS signal:
receiving a pilot signal; and
transmitting a channel quality indicator only when reception power of the received pilot signal is equal to or larger than a predetermined threshold value.
